(19) United States
(12) Patent Application Publication
(10) Pub. No.: US 2003/0152201 A1
(43) Pub. Date: Aug. 14, 2003

(54) Voicemail for wireless systems

(76) Inventors: William M Snelgrove, Toronto (CA); Michael Stumm, Toronto (CA); Mark James Frazer, Toronto (CA); Gavin Wayne Kenny Peters, Toronto (CA); Mauricio De Simone, Toronto (CA)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/239,829

(22) PCT Filed: Mar. 21, 2001
(86) PCT No.: PCT/CA01/00371

(51) Int. Cl. H04M 1/64

(52) U.S. Cl. 379/88.22

(57) ABSTRACT

The present invention provides a novel system, method and apparatus for managing voicemails over a wireless local loop. The system provides for the placement of a voicemail client local to the subscriber and a voicemail server at the base station. The voicemail server and voicemail client cooperate with the base station to determine appropriate times to transfer voicemails over the WLL and thereby free-up bandwidth on the WLL for higher priority traffic, such as voice calls. Another embodiment of the invention provides a method for receiving voicemails utilizing the system. Yet another embodiment provides a method for delivery of voicemails from a caller to destination subscriber. Various prioritization criteria can be used to provided desired utilization of bandwidth.

### FIELD OF THE INVENTION

The present invention relates to a system, apparatus and method of providing user-services over wireless telecommunications services, or the like. More specifically, the present invention relates to providing voicemail and similar or related services in a manner which can provide good usage of the communication link, such as the available radio spectrum in a wireless system.

### BACKGROUND OF THE INVENTION

Telephone answering machines are well known. Early answering machines comprised a tape-recorder and player connected to the phone jack of a telephone subscriber. When the subscriber was unable to answer the phone, the answering machine would automatically ‘pick-up’ the phone, play an outgoing message to the caller, and record an incoming message for later play-back. However, such answering machines were prone to breakdown and/or failure. For example, the tape could stretch resulting in poor audio performance. In addition, in the event of a power-failure certain machines could not operate.

In industrialized nations such as Canada and the U.S., voicemail systems have all but replaced the old-fashioned answering machine. One known type of voicemail system is provided by many local companies. Such voicemail systems are typically resident at the central office respective to the subscriber's residence. Voicemail systems offer certain advantages over the answering machine, in that there is no ‘tape’ to stretch, and in general, maintenance of such systems is centralized, thus shifting maintenance responsibilities away from the subscriber. Voicemail systems offer another advantage over traditional answering machines, in that they will record messages while the subscriber's line is in use—thus obviating the annoying ‘busy signal’. Overall, voicemail systems offer richer functionality over traditional telephone answering machines.

Telephony has seen other major advances in addition to voicemail. For example, cellular and other wireless systems are now widely deployed. Recently much interest has been expressed in providing local loop services via wireless systems. As known to those of skill in the art, wireless local loop (WLL) systems are systems that connect subscribers to a public switched telephone network (PSTN) using radio signals to exchange information as a substitute for copper wiring over all or part of the connection between the subscriber and the switch. WLL systems have been installed in various locations to date, primarily developing nations where the cost to establish a copper wire infrastructure for local loop services is very high. In more industrialized locations, where a copper wire infrastructure already exists, great interest in WLL also exists to provide competition in local access services.

Generally, WLL systems developed and/or proposed to date build upon techniques and technologies developed for cellular mobile systems, including analog cellular and GSM or CDMA cellular. Such systems have proven to be very successful to date at providing mobile wireless communications and much development has been performed with respect to their technologies.

The present inventors have determined however, that while WLL systems based upon mobile cellular technologies can provide reasonable voice performance, they do not provide a cost effective range of services and/or bandwidth efficiencies that will be desired for WLL systems. Specifically, the incorporation of traditional voicemail systems into WLL systems can result in inefficient use of bandwidth. For example, the transmission of low-priority voicemails may clutter the WLL, consuming valuable and limited bandwidth during peak capacity times.

It is therefore desired to have a system, apparatus and method to provide voicemail services which allows wireless communications to be provided in a efficient manner.

### SUMMARY OF THE INVENTION

It is an object of the present invention to provide a novel system, apparatus and method of providing voicemail services over a communication link which obviates or mitigates at least one of the above-identified disadvantages of the prior art.

In one aspect of the invention there is provided a voicemail system for a communication link comprising a voicemail server connected to a first network node, and a voicemail client connected to a second network node. The voicemail client is operable with the voicemail server to transceive voicemail messages therebetween via the communication link according to a desired prioritization criteria, such as tranceiving the voicemail when there is available resources over the communication link.

In a particular implementation of the first aspect, the communication link is a wireless local loop; the first network node is a wireless base station including an antenna, a radio, a modem, a router; and the second network node is wireless a subscriber station including an antenna, a radio unit and modem, the subscriber station being operable to transceive communications with the base station, the voicemail client being operable with the voicemail server to transceive voicemail messages therebetween according to the prioritization criteria. In this particular implementation, the prioritization criteria can include, for example, whether there is available bandwidth over the wireless local loop.

In another aspect of the invention there is provided a method of updating voicemail features for a subscriber station in a wireless local loop, (or other type of communication network) having a base station operable to exchange information with the subscriber station, the base station having a voicemail server, the method comprising the steps of:

receiving data at the subscriber station representative of a request from a subscriber to update a voicemail feature;

initiating a voicemail program in the subscriber station;

receiving data representative of desired changes to the voicemail features;

opening a channel between the subscriber station and the base station;

transmitting the data representative of desired changes to the base station; and

updating the voicemail feature in voice server at the base station using the transmitted data.

In a particular aspect of the method, there is further provided, after the receiving step, the additional step of confirming the desired changes with the subscriber prior to the opening step, and repeating the receiving step and the confirming step until the subscriber accepts the desired changes.

The present invention provides a novel system, method and apparatus for managing voicemails over a wireless local loop. The system provides for the placement of a voicemail client local to the subscriber and a voicemail server at the base station. The voicemail server and voicemail client cooperate with the base station to determine appropriate times to transfer voicemails over the WLL and thereby free-up bandwidth on the WLL for higher priority traffic, such as voice calls. Another embodiment of the invention provides a method for receiving voicemails utilizing the system. Yet another embodiment provides a method for delivery of voicemails from a caller to destination subscriber. Various prioritization criteria can be used to provide desired utilization of bandwidth.

### BRIEF DESCRIPTION OF THE DRAWINGS

Preferred embodiments of the present invention will now be described, by way of example only, with reference to the attached Figures, wherein:

FIG. 1 shows a schematic representation of a WLL system in accordance with the present invention;

FIG. 2 shows a schematic representation of a subscriber station in the system of FIG. 1;

FIG. 3 shows a schematic representation of a base station in the system of FIG. 1; and

FIG. 4 shows a method for receiving voicemails in accordance with another embodiment of the invention; and,

FIG. 5 shows a method for delivering voicemails in accordance with another embodiment of the invention.

### DETAILED DESCRIPTION OF THE INVENTION

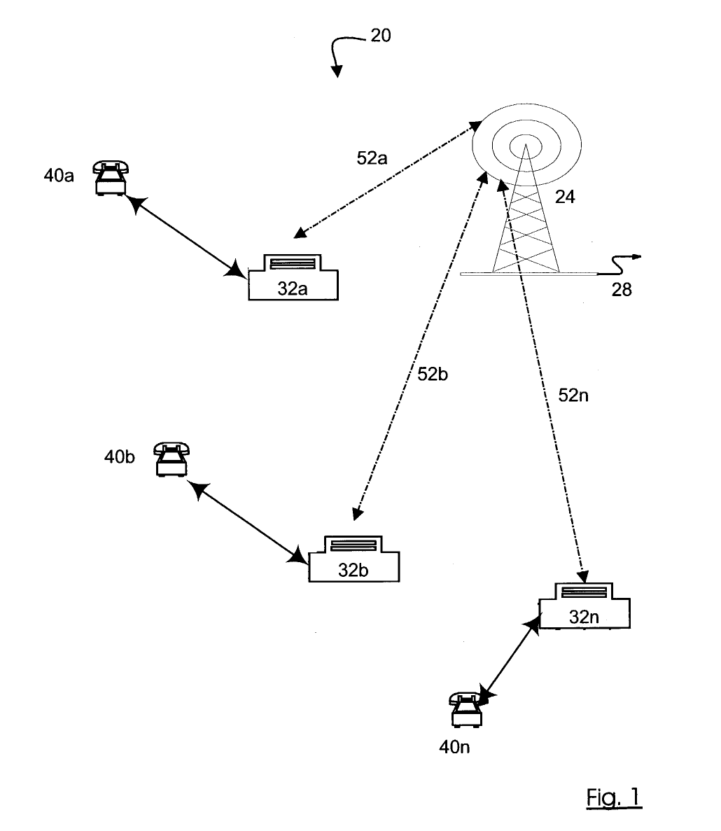

Referring now to FIG. 1, a WLL including a voice mail system in accordance with an embodiment of the present invention is indicated generally at 20. System 20 includes a radio base station 24 which is preferably connected to voice and/or data telecommunications network (not shown), such as a land line-based switched telephone network and/or data network, by an appropriate gateway and one or more backhauls 28. A backhaul 28 can be a T1, T3, E1, E3, OC3 or other suitable land line link, or can be a satellite or other radio or microwave channel link or any other link suitable for operation as a backhaul as will occur to those of skill in the art.

Base station 24 communicates with a plurality of subscriber stations 32 which are installed at subscriber premises. The number ‘n’ subscriber stations can vary depending upon the amount of radio bandwidth available and/or the configuration and requirements of the subscriber stations 32. In the present embodiment, system 20 has a bandwidth capacity that is generally capable of simultaneously carrying less than the ‘n’ channels, depending upon the types of communication being carried over the channels. Such capacity can be determined based on known statistical models and methods for determining the likely maximum number of subscriber stations 32 that will simultaneously require a communication channel 52.

In the illustrated embodiment of the present invention, each subscriber station 32 includes at least one telephony port, such as a standard RJ-11 jack, for a conventional telephone set 40. It is to be understood that additional telephony ports for facsimile and/or data can be provided in each subscriber station if desired. The provided data port can be an Ethernet or USB port, or any other suitable connector/port for interfacing a computer or other information appliance to a data network available via backhaul 28.

Communications channels 52 are established between base station 24 and each subscriber station 32. Channels 52 allow information to be transferred between base station 24 and respective subscriber stations 32 as needed. In a present embodiment, the radio-communication protocol employed for channels 52 is digitally based, such as GSM or CDMA. The implementation/type of packet communication employed is not particularly limited, and can include IP (with TCP or UDP) and/or modifications thereof or any other packet implementation as will occur to those of skill in the art. While the present embodiment is directed to digitally-based radio communications, it will be understood that the present invention can be suitably modified to accommodate analog based radio communications, such as that found in analog cellular telephone networks.

Furthermore, it will be understood that system 20 can have additional base stations 24, as desired, where some subscriber stations 32 are within range of two or more base stations 24, and that communications between multiple base stations 24 and subscriber stations 32 can be managed using known soft-handoff techniques. Other known wireless architectures can be employed. For example, base station 24 can be multi-sectored, each sector being defined by directional antennas, each sector comprising a different reception footprint and thus allowing reuse of available spectrum between sectors serviced from a single base station 24.

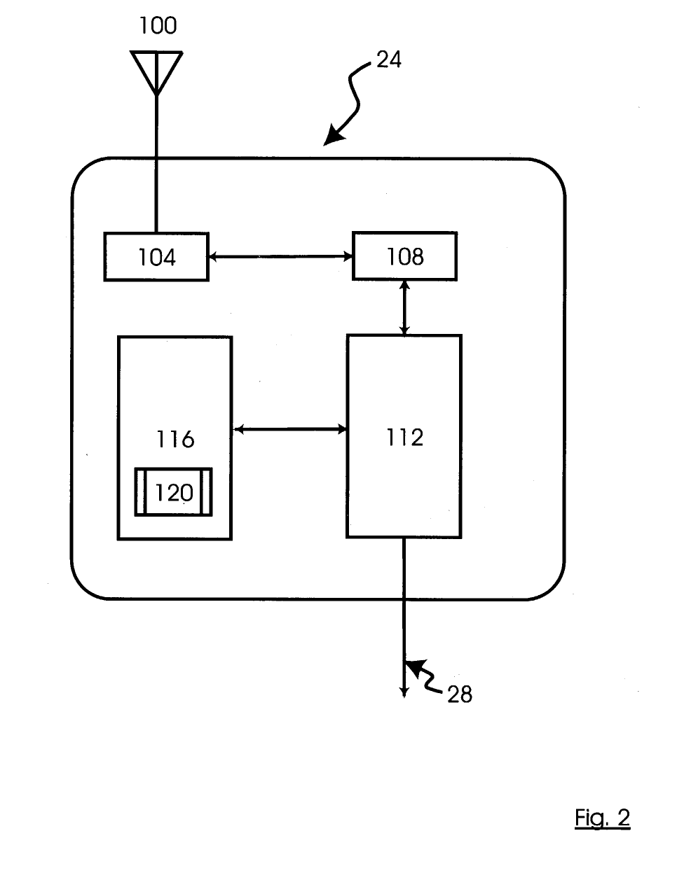

FIG. 2 shows base station 24 in greater detail. Base station 24 comprises an antenna 100 for transceiving radio-communications over communication channel 52. In turn, antenna 100 is connected to a radio 104 and a modem 108. Modem 108 is connected to a microprocessor-router assembly 112. A suitable microprocessor would be a SPARC processor system manufactured by SUN Microsystems. It will be understood that assembly 112 can include multiple microprocessors, as desired.

The router within microprocessor-router assembly 112 is connected to backhaul 28 in any suitable manner, which in turn connects base station 24 to a PSTN gateway (not shown) and/or to a packet switched data network (not shown). Depending upon the amount of data traffic to be transferred, backhaul 28 can comprise one or more T1, T3, E1, E3, OC3, microwave, satellite or other suitable telecommunication links as will occur to those of skill in the art.

A voicemail server 116 is also connected to microprocessor-router assembly 112. Voicemail server 116 includes a persistent storage device (not shown) for storing voicemails respective to each subscriber 32 and includes a microprocessor (not shown) and a voicemail-manager 120. As will be discussed in greater detail below, voicemail-manager 120 is, in general, operable to store and/or manage voicemails for each subscriber station 32 serviced by base station 24.

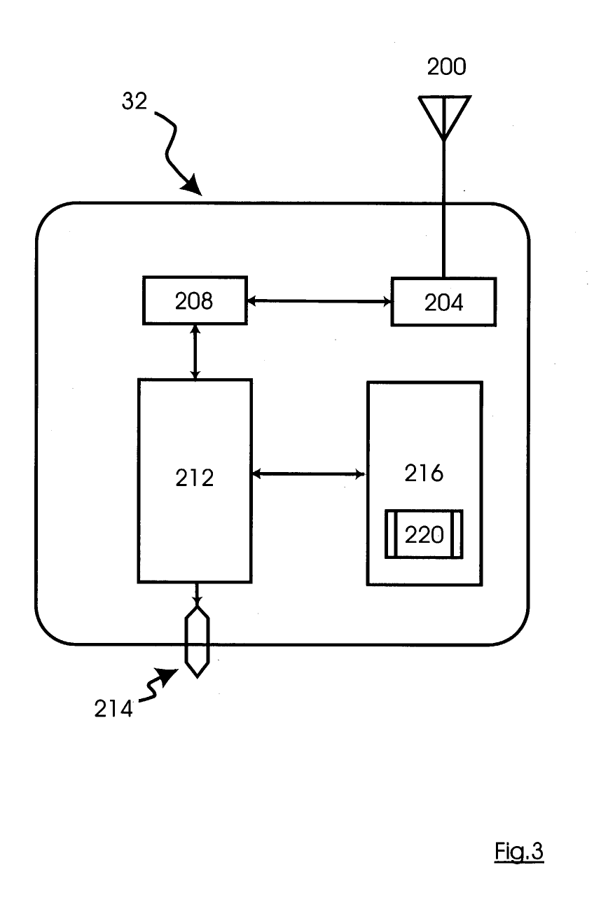

Referring now to FIG. 3, subscriber station 32 is shown in greater detail. Subscriber station 32 comprises an antenna 200 for transceiving radio-communications over communication channel 52. (As used herein the term “transceive” and “transceiving” means to transmitting and/or receiving.) In turn, antenna 200 is connected to a radio 204 and a modem 208, which in turn is connected to a microprocessor-assembly 212.

Microprocessor-assembly 212 which can include, for example, a StrongARM processor manufactured by Intel, performs a variety of functions, including implementing A/D-D/A conversion, voice codecs, filters, encoders, data compressors and/or decompressors, packet assembly/disassembly. As seen on FIG. 2, microprocessor-assembly 212 interconnects modem 208 and the previously-described telephony port 214. Accordingly, microprocessor-assembly 212 is operable to processes voice-telephone calls between telephone set 40 (connected to port 214) and modem 208.

Subscriber station 32 also includes a voicemail client 216 (which is connected to microprocessor assembly 212) that is operable in conjunction with voicemail server 116 to transceive voicemail messages in accordance with prioritization criteria. Voicemail client 216 includes a persistent storage device (not shown) for locally storing voicemails respective to each subscriber 32 and includes a microprocessor (not shown) and a voicemail-manager 220. Various prioritization criteria can be used and are within the scope of the present invention, the details of which will be discussed in greater detail below.

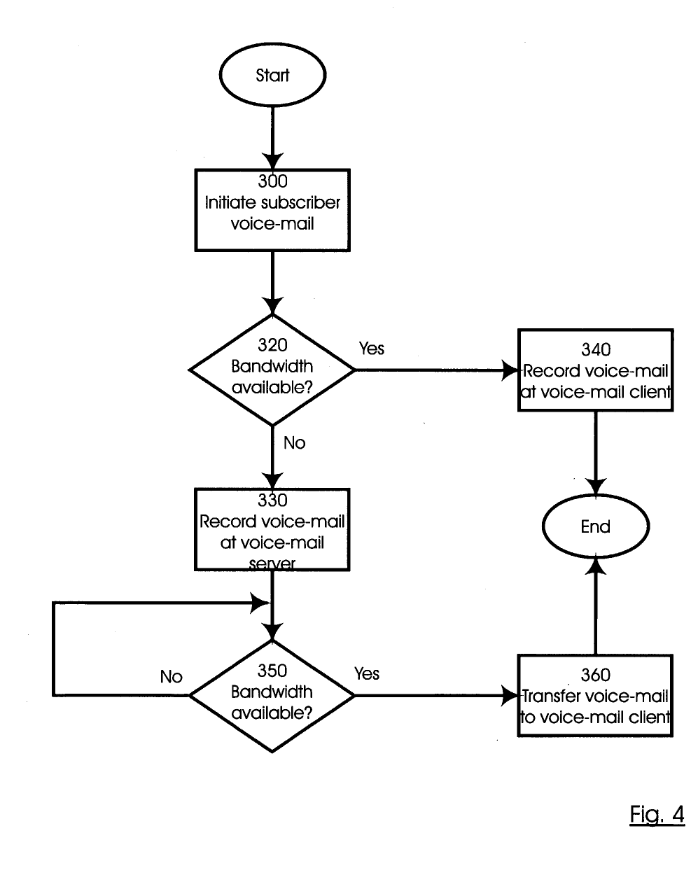

Referring now to FIG. 4, a method of delivering a voicemail over a WLL is shown. For purposes of explaining the method, reference will be made to system 20 and FIGS. 1-3. Beginning at step 300, a subscriber's voicemail is activated. The activation can occur using any means known in the art. For example, a telephone call directed to subscriber station 32a is received at base station 24 from a PSTN connected to backhaul 28. Microprocessor-router assembly 112 then opens channel 52a and telephone handset 40a begins ringing. After a predetermined number of rings when telephone handset 40a is not answered, voicemail manager 120 is notified and initiates the subscriber's voicemail service. (Other means of initiating the subscriber's voicemail will occur to those of skill in the art.)

At step 320, the availability of bandwidth for carrying the voicemail addressed to subscriber station 32a is determined. Such a determination can be based on any desired set of predefined prioritization criteria. In a presently preferred embodiment, the prioritization considers the quantity of traffic simultaneously active on channels 52b . . . 52n. (Recall that system 20 could have capacity to simultaneously carry somewhat less than ‘n’ channels 52, even though there are ‘n’ subscriber stations 32.) For purposes of explaining the present embodiment, it will be assumed that a sufficient number of channels 52b . . . 52n are active on system 20 such that only a small amount of radio bandwidth remains available in the event additional subscriber stations 32 attempt to initiate telephone calls. Continuing with the present example, it is thus determined at step 320 that insufficient bandwidth is available, (or system 20 wishes to keep such remaining bandwidth available for voice communications or other higher priority communications) to carry the voicemail addressed to subscriber-station 32a, and the method advances to step 330, where the voicemail is recorded on voicemail server 116 for later transfer to subscriber-station 32a. It will now be apparent that, at this point, channel 52a is not in use and radio bandwidth which would otherwise have been assigned to it is thus made available the remaining subscriber stations 32b . . . 32n.

The method then advances to step 350 where the availability of bandwidth for carrying the voicemail addressed to subscriber station 32a is determined once again. The determination can be made using a substantially identical set of prioritization criteria used at step 320. If it is determined that bandwidth is still unavailable then the method loops back to 350 in order to continually monitor system 20 until a sufficient amount of bandwidth does become available. Once it is determined that bandwidth is available on system 20, then the method moves to step 360.

At step 360, channel 52a has radio bandwidth assigned to it and the voicemail stored on voicemail server 116 is passed to microprocessor-router 112, transmitted over channel 52a, received by subscriber station 32a and stored on voicemail client 216 for later local playback at subscriber station 32a.

Notwithstanding the foregoing example, it will be understood that, if it was determined at step 320 that there was sufficient bandwidth available, then the method would advance therefrom directly to step 340. At step 340, channel 52a is left open and the voicemail is recorded directly on voicemail client 216 for local playback at subscriber station 32a.

It is contemplated that the method of FIG. 4 can be varied and modified to accommodate different needs and requirements. For instance, the prioritization criteria used to determine available bandwidth at step 320 can be based on other considerations in addition to, or in lieu of, the capacity of system 20. For example, each subscriber-station 32a . . . 32n can be associated with base station 24 in accordance with a service agreement that dictates the priority given to each subscriber-station 32a . . . 32n in relation to each other. Such a service agreement can, for example, assign gold, silver and bronze levels of service, (typically having different levels of monetary consideration being charged for each level of service) whereby a subscriber station 32 with gold service can be allocated radio bandwidth for a channel 52 with a greater priority than radio bandwidth for a channel 52 associated with a subscriber station 32 with bronze service. In effect, a gold subscriber would have their voicemails given priority for storage directly on voicemail client 216 over a bronze subscriber. Other prioritization criteria will occur to those of skill in the art.

The prioritization criteria used at step 350 can also include a maximum-allowed waiting period before transfer of the voicemail message to voicemail client 216. Accordingly, the priority of transferring a voicemail can be increased at a predetermined rate, the longer that the particular voicemail has been resident on voicemail server 116. Similarly, a plurality of voicemails stored on voicemail server 116 can be transferred to their appropriate voicemail client 216 on a first-in-first-out (FIFO) basis. Other prioritization criteria will occur to those of skill in the art.

It is also contemplated that, where the voicemail is recorded on voicemail server 116 and awaiting transfer to voicemail client 216, then a notice (i.e. a signal carried over channel 52 that occupies substantially less bandwidth than the actual voicemail) can be delivered to the appropriate subscriber station 32 in the event that a subscriber respective to the subscriber-station 32 wishes to access the voicemail prior to the transfer of the voicemail from voicemail server 116 to voicemail client 216 that would normally occur at step 360 of the method shown in FIG. 4. Such a notice can be expressed at subscriber station 32 in the form of, for example, a flashing light mounted on the subscriber-station 32 or stutter dial tone signal. Should the subscriber choose to access the voicemail while it is still stored on voicemail server 116, then bandwidth can be allocated to a channel 52 to allow the voicemail to be played immediately to the subscriber.

It is further contemplated that the transfer of voicemail from voicemail server 116 to voicemail client 216 can be performed in a number of ways to suit the bandwidth requirements of remaining subscriber stations 32b . . . 32n. For example, channel 52 can have more bandwidth allocated to it, when available, than is necessary to transfer the voicemail at the normal playback rate in order to occupy channel 52a for less time during the transfer and to make efficient use of available bandwidth than when it is otherwise used for regular voice telephone calls. Alternatively, channel 52a can have lower bandwidths allocated to it than is generally required for transfer of voice mail at the normal playback rate in order to reduce required bandwidth while still providing for the timely delivery of the voice mail. In either of these two examples, once the voicemail is fully received by voicemail client 216, it can then be made available for local playback at subscriber station 32. Similarly, the voicemail can be transferred in ‘bursts’, thus requiring that channel 52a only have bandwidth allocated intermittently. Bursty transmission of the voicemail can allow the transfer to be interrupted, for later resumption, in the event that another subscriber 32b . . . 32n has an immediate need for the bandwidth allocated to channel 52a. Other variations on the transmission of the voicemail between voicemail server 116 and voicemail client 216 will now be apparent to those of skill in the art.

It is further contemplated that an introductory, or other suitable portion, of the voicemail can be stored on voicemail client 216, and the remainder of the voicemail stored on server 116, in lieu of transferring the entire voicemail. In this situation, the subscriber can screen voice mails by listening to the portion available and then access the remainder of the voicemails of interest which can be streamed to subscriber station 32 from voicemail server 116.

It is also contemplated that steps 320 and 340 of the method of FIG. 4 can be eliminated, such that the voicemail is always recorded directly onto voicemail server 116 for subsequent transfer to voicemail client 216 when the desired bandwidth is available. This can be accomplished using method of FIG. 4 by setting the threshold of bandwidth available at step 320 that is required to advance the method to step 340 to a level that can never be satisfied.

It is also contemplated that the prioritization criteria can be dynamically updated to reflect bandwidth availability and needs and subscriber requirements at different times.

It will also be understood that the method of FIG. 4 is also applicable for calls and voicemail messages between subscriber stations 32 within system 20.

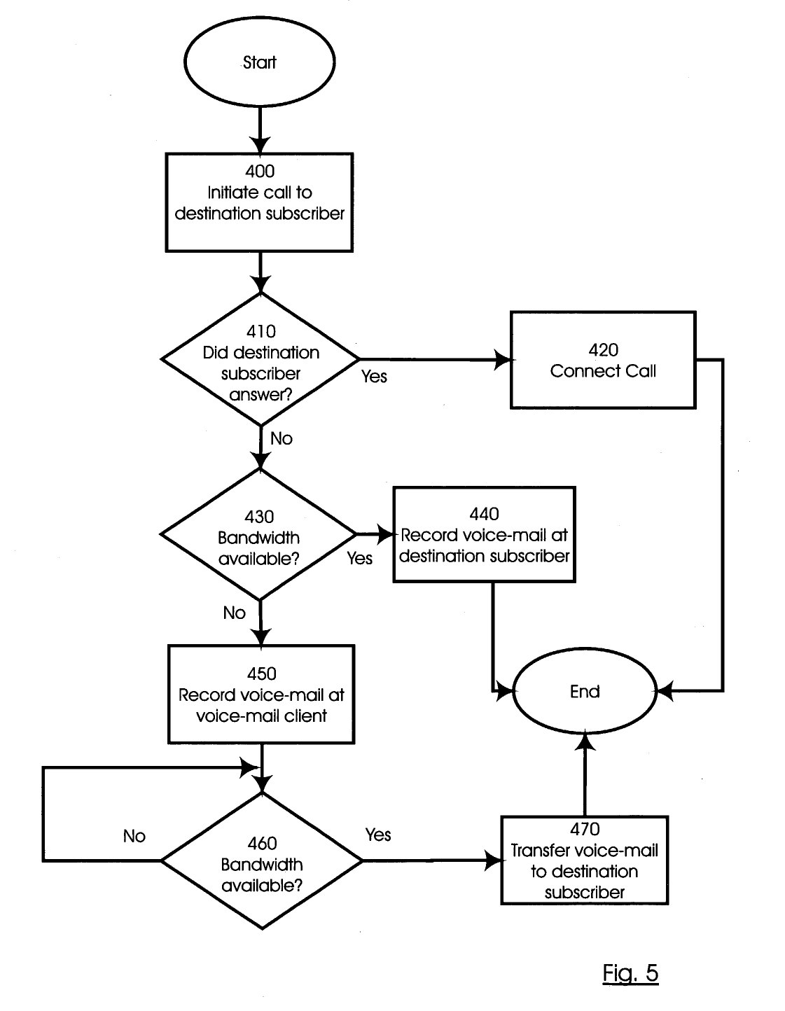

A method in accordance with another embodiment of the invention is shown in the flow-chart of FIG. 5. The method of the present embodiment is directed to the management of outgoing voicemails from a subscriber station 32 in system 20. For the sole purposes of explaining the present embodiment, it will be assumed that a caller at subscriber station 32a is attempting to call to a destination subscriber connected to system 20 via the PSTN connected through backhaul 28. It will be further assumed that the destination subscriber has a voicemail system associated with his or her service, and that system 20 is operable to signal base station 24 that the destination subscriber's voicemail system has been activated.

Referring now to FIG. 5, at step 400 the caller at subscriber station 32a initiates the call to the destination subscriber. Next, at step 410, it is determined whether the destination subscriber answers the call. This can be accomplished, for example, by determining whether the destination subscriber's voicemail system has been activated. If it is determined that the destination subscriber answered the call, then the method moves to step 420 where the call is connected and the method then ends.

However, if it is determined that the destination subscriber did not answer the phone and/or that the phone is busy, then the method advances to step 430 where it is determined whether there is bandwidth available for carrying the voicemail message. The determination made at step 430 can be made using substantially the same prioritization criteria, with appropriate modifications, used to make the determination at step 320 of the previous embodiment. Accordingly, if there is enough bandwidth available, the method moves to step 440, where channel 52a maintains the bandwidth allocated to it while the voicemail message being left by the caller at subscriber station 32a is recorded on the voicemail service of the destination subscriber.

However, if, at step 430, it is determined that there is insufficient bandwidth available, or if it is desired to reallocate that bandwidth to other subscribers in system 20, then the method advances to step 450, where the voicemail is recorded on voicemail client 216 while the bandwidth previously allocated to channel 52a is deallocated. The caller at subscriber station 32a dictates the voicemail for the destination subscriber in the usual fashion, but the actual voicemail is recorded on voicemail client 216.

The method then advances to step 460, where the bandwidth available on system 20 is continuously monitored until sufficient bandwidth is available and/or other prioritization criteria are met, such as the expiry of a maximum voicemail aging period. It is presently preferred that this step is implemented by having voicemail client 216 send a short (i.e. low bandwidth) message to microprocessor-router 112 indicating that voicemail client 216 has a voicemail message ready for transfer. In turn, microprocessor-router 112 continuously monitors the traffic over system 20 to determine the available bandwidth. The prioritization criteria used by microprocessor-router 112 is substantially the same criteria used at step 350 of the method shown in FIG. 4, with appropriate modifications. Referring again to FIG. 5, as long sufficient bandwidth is not available and/or other criteria are not met, the method continuously loops back to step 460.

Once it is determined that sufficient bandwidth is available and/or any the other criteria is met, then the method advances to step 470, at which point channel 52a has bandwidth allocated for it and the voicemail message is transferred from voicemail client 112, over communication channel 52a and to microprocessor-router 112, which then delivers the voicemail to the voicemail-box of the destination subscriber. Such delivery can be done using existing voicemail delivery services offered over the PSTN. For example, a system such as the Universal Messaging™ service offered by Bell Canada can be used to deliver the voicemail. As was the case above, the transfer of voice mail messages can be performed at rates greater or less than the normal playback rates of the voice mail to efficiently use any available bandwidth in system 20.

It will also be understood that the method of FIG. 5 is also applicable for calls and voicemail messages between subscriber stations 32 within system 20, i.e. from one subscriber station 32a to another subscriber station 32b.

It is contemplated that the method of FIG. 5 can be varied and/or modified to accommodate different needs and requirements. For instance, where the destination subscriber does not have voicemail and the caller at subscriber station 32a encounters a busy signal at step 410, then the method can still proceed to allow the caller at subscriber station 32a to leave a voicemail message on voicemail client 216. In turn, this voicemail message is scheduled for delivery to the destination subscriber. In this situation, at step 470 the voicemail would be transferred from voicemail client 216 to voicemail server 116. Once the message was transferred to voicemail server 116, then voicemail server 116 would initiate periodic calls to the destination subscriber, and, once the destination subscriber answered the phone, (or a traditional answering machine located at the destination subscriber answered the phone), then voicemail server 116 would play the message to the destination subscriber.

It is also contemplated that the methods of FIG. 4 and FIG. 5 can be used in conjunction to manage the delivery and receipt of a single voicemail.

It will now be apparent that the variations described with the method shown in FIG. 4 can be modified, if and as appropriate, to vary the functionality of the method shown in FIG. 5.

While the embodiments discussed herein are directed specific implementations of the invention, it will be understood that combinations, sub-sets and variations of the embodiments are within the scope of the invention. For example, it is contemplated that the present can be suitable for other types of communication links and/or networks in addition to WLL, such as wired networks (e.g. voice over DSL services, or voice over CATV services), and can be particularly useful in any communication link and/or network where the management of bandwidth or other communication resources is desirable. Furthermore, it is contemplated that the present invention can be applied to mobile cellular technology, including those employing CDMA, TDMA, FDMA or other multiple access techniques or combinations thereof, as mobile handsets are provided with additional persistent storage and/or processing capabilities that allow the incorporation of a voicemail client therein.

When implemented in other types of communication network, the voicemail server can be resident at a first node of the network and the voicemail client resident at a second node network. The first and second nodes are connected by the communication link. (As will be understood by those of skill in the art, the link can include any number of additional nodes through which a communication must pass when traveling between the first and second nodes.) Thus, where the communication network includes wireless local loop system 20, then the first node could be base station 24 and the second node could be subscriber station 32. It is also contemplated that each node could be a subscriber station 32, and that a communication link therebetween would be composed of two channels established via base station 24. However, such a communication link would be established according to the prioritization criteria—for example, opening the link at a time mutually convenient to each subscriber station 32 and which takes into account available bandwidth of WLL system 20. It is to be understood that in this example, the voicemail client and voicemail server described hereabove maybe substantially the same device, each located at the subscriber's premises, and in which case such a connection would be more akin to a peer-to-peer relationship, and the terms “voicemail client” and “voicemail server” are used for convenience only.

Where the communication network includes a voice over DSL system, then, for example the first node could be the digital subscriber line access multiplexor (“DSLAM”) at the telephone company switch, and the second node could be the digital subscriber line (“DSL”) modem at the subscriber premises. It is also contemplated that the present invention can be suitable for transfer of other data to a subscriber station from a base station, such as faxes, electronic mail, text messages and the like. Other types of communication networks and/or links and/or respective nodes will now be apparent to those of skill in the art.

It is also contemplated that the present invention can be modified to allow the local modification or updating of voicemail features at the subscriber station, and then downloading the complete set of changes to the voicemail server once the features had been modified. Such voicemail features can include, greetings, passwords, number of rings before answering and so on. This can further reduce the use of bandwidth as a subscriber at a subscriber station can, for example, update his or her voicemail greeting locally at the voicemail client and replay and re-record the greeting as many time as desired, without consuming bandwidth. Once the subscriber at the subscriber station has updated the voicemail greeting to his or her satisfaction, the final greeting can be downloaded to the voicemail server.

It is also contemplated that, where a subscriber is trying to make an outgoing call, the subscriber can be given the option, by way of an interactive voice response (IVR) menu or entering a key-sequence, of paying an increased amount for the telephone call, or paying a lower amount for leaving a voicemail on voicemail client 216 which is stored for later download to voicemail server 116 and subsequent transfer to the destination caller.

Similarly, where a caller wishes to call a subscriber at a subscriber station, and there is a great deal of traffic on the system, the caller can be given an option of leaving a voicemail on voicemail server 116 for later upload to voicemail client 216 and in exchange for being charged a reduced amount of monetary (or other)consideration for the call.

The present invention provides a novel, system, method and apparatus for managing voicemails over a WLL or other wireless or wired systems. The presence of a voicemail client local to a subscriber and that cooperates with a voicemail server local to the base station allows for the transception of the voicemail according to any desired prioritization criteria, and thereby more effectively utilize available bandwidth and/or other communication resources. In addition, various prioritization criteria can be conceived to suit individual subscriber and overall system needs and requirements, and thereby provide additional flexibility in the management of voicemails over the WLL or other communication network.

The above-described embodiments of the invention are intended to be examples of the present invention and alterations and modifications may be effected thereto, by those of skill in the art, without departing from the scope of the invention which is defined solely by the claims appended hereto.

We claim:

1. A voicemail system for a communication link comprising:
a voicemail server connected to a first network node; and,
a voicemail client connected to a second network node operable with said voicemail server to transceive voicemail messages therebetween via said communication link according to a prioritization criteria.

2. The voicemail system according to claim 1 wherein said communication link is a wireless local loop; said first network node is a wireless base station including an antenna, a radio, a modem, a router; and said second network node is wireless a subscriber station including an antenna, a radio unit and modem, said subscriber station being operable to transceive communications with said base station, said voicemail client being operable with said voicemail server to transceive voicemail messages therebetween according to said prioritization criteria.

3. The voicemail system of claim 1 or 2 wherein said prioritization criteria includes available bandwidth over said communication link.

4. The voicemail system of claim 2 wherein said prioritization criteria includes a level of service subscribed by each said subscriber station, said level of service reflecting a priority of allocating bandwidth in relation to at least one other said subscriber station having a different level of service.

5. The voicemail system of claims 1-4 wherein when a voicemail message is awaiting transfer between said server and said client said prioritization criteria includes a maximum acceptable aging period of a voicemail message awaiting transfer.

6. The voicemail system of claim 1-5 wherein when a plurality of voicemail messages are awaiting transfer between said server and said client, said prioritization criteria includes a processing of said plurality of voicemail messages on a first-in-first-out basis.

7. The voicemail system of claims 1 wherein said server and said client are each operable to compress a voicemail prior to transfer from said first network node and decompress said compressed voicemail upon receipt at said second network node.

8. The voicemail system of claims 1-7 wherein said server and said client are operable to transfer said voicemail in bursts.

9. The voicemail system of claim 2, 6 or 7 wherein said server and said client are operable to transfer said voicemail over a channel between said antennas that is different in bandwidth than used to carry a voice telephone call.

10. The voicemail system of claim 9 said channel is smaller and said server and said client are operable to transfer a voicemail a slower rate than used to carry a voice telephone call therebetween.

11. The voicemail system of claim 9 said channel is smaller and a voicemail is transferable at a slower rate than used to carry a voice telephone call therebetween.

12. The voicemail system of claim 1 wherein said subscriber station is operable to present a notice to a subscriber respective to said subscriber station that said subscriber has a voicemail message.

13. The voicemail system of claim 12 wherein said notice is a stutter-dial tone.

14. The voicemail system according to claim 1 wherein said communication link is a voice over DSL network; said first network node is a DLSAM; and said second network node is a subscriber station includes a DSL modem, said subscriber station being operable to transceive communications with said DSLAM, said voicemail client being operable with said voicemail server to transceive voicemail messages therebetween according to said prioritization criteria.

15. The voicemail system according to claim 1 wherein said communication link is the internet; said first network node is first subscriber station; and said second network node is a second subscriber station, said subscriber stations being operable to transceive communications therebetween, said voicemail client being operable with said voicemail server to transceive voicemail messages therebetween according to said prioritization criteria.

16. A voicemail client for a subscriber station in a wireless local loop, said subscriber station including an antenna, a radio unit and a modem, said subscriber station being operable to transceive communications with said a base station for said wireless local loop, said base station including an antenna, a radio, a modem, a router, said voicemail client comprising:
a persistent storage device for storing at least one voicemail; and,
a processing means operable to communicate with said subscriber station, said processing means being further operable with a voicemail server local to said base station for transferring said at least one voicemail message therebetween.

17. A voicemail server for a base station in a wireless local loop, said base station including an antenna, a radio unit and a modem, said base station being operable to exchange information with at least one subscriber station for said wireless local loop, said subscriber station including an antenna, a radio, a modem, a router, said voicemail server comprising:
a persistent storage device for storing at least one voicemail; and
a processing means operable to communicate with said base station, said processing means being further operable with a voicemail server local to said base station for transceiving said at least one voicemail message therebetween.

18. A method for processing voicemail messages in a wireless local loop having a base station operable to transceive communication with a subscriber station, said base station having a voicemail server that is operable with a voicemail client local to said subscriber station to transfer voicemail messages therebetween, said method comprising the step of:
transceiving a voice-mail between said base station and said subscriber station based on prioritization criteria.

19. A method for processing voicemail messages in a wireless local loop having a base station operable to exchange information with a subscriber station, said base station having a voicemail server that is operable with a voicemail client local to said subscriber station to transfer voicemail messages therebetween, said method comprising the steps of:
receiving, at said base station, a telephone call destined for said subscriber station; initiating a voicemail program in said voicemail server;
determining whether there is sufficient bandwidth available for allocating a channel between said base station and said subscriber station based on prioritization criteria; recording a voicemail on said voicemail client if sufficient bandwidth is immediately available; and
recording said voicemail on said voicemail server if insufficient bandwidth is immediately available, said recording on said voicemail server for subsequent transferal of said voicemail to said voicemail client when sufficient bandwidth becomes available.

20. A method for processing voicemail messages in a wireless local loop having a base station operable to exchange information with a subscriber station, said base station having a voicemail server that is operable with a voicemail client local to said subscriber station to transfer voicemail messages therebetween, said method comprising the steps of:
initiating a call from said subscriber station to a destination subscriber;
initiating a voicemail program in said voicemail client if said destination subscriber does not answer;
determining whether there is a sufficient bandwidth available for allocating a channel between said base station and said subscriber station based on prioritization criteria; recording a voicemail at one of said voicemail server and said destination subscriber if sufficient bandwidth is immediately available; and
recording said voicemail on said voicemail client if insufficient bandwidth is immediately available, said recording on said voicemail client for subsequent transferal of said voicemail to one of said voicemail server and said destination subscriber when sufficient bandwidth becomes available.

21. The method of claim 15, 16 or 17 wherein said prioritization criteria includes available bandwidth over said WLL.

22. The method of claim 15, 16, 17 or 18 wherein said prioritization criteria includes a level of service subscribed by each said subscriber station, said level of service reflecting a priority of bandwidth in relation to at least one other said subscriber station.

23. The method of claim 15 or 16 wherein when a voicemail message is awaiting transfer between said server and said client said prioritization criteria includes a duration of time said voicemail message has been awaiting transfer.

24. The method of claim 15, 16 or 20 wherein when a plurality of voicemail messages are awaiting transfer between said server and said client, said prioritization criteria includes a processing of said plurality of voicemail messages on a first-in-first-out basis.

25. The method of claims 15-21 wherein said server and said client are each operable to compress a voicemail prior to transfer and decompress said compressed voicemail upon receipt.

26. The method of claims 15, 16, 17, 18, 19, 21 or 22 wherein said server and said client are operable to transfer said voicemail in bursts.

27. The method of claim 15, 16 or 17 wherein said server and said client are operable to transfer said voicemail over a channel between said antennas that is different in bandwidth than used to carry a voice telephone call.

28. The method of claim 24 said channel is smaller and a voicemail is transferable at a slower rate than used to carry a voice telephone call.

29. A method of updating voicemail features for a subscriber station in a wireless local loop having a base station operable to exchange information with said subscriber station, said base station having a voicemail server, said method comprising the steps of:
receiving data at said subscriber station representative of a request from a subscriber to update a voicemail feature;
initiating a voicemail program in said subscriber station;
receiving data representative of desired changes to said voicemail features;
opening a channel between said subscriber station and said base station;
transmitting said data representative of desired changes to said base station; and updating said voicemail feature using said transmitted data.

30. The method of claim 26 wherein said feature is a greeting.

31. The method of claim 26 wherein said channel is opened based on prioritization criteria.

32. The system of claim 3 wherein said prioritization criteria is dynamically changed by said subscriber.

33. The system of claim 3 wherein said prioritization criteria is changed based on consideration remitted by a subscriber local to said subscriber station.

34. The system of claim 30 wherein said consideration is monetary.

35. The method of claim 19 wherein said prioritization criteria is dynamically changed by said subscriber.

36. The method of claim 19 wherein said prioritization criteria is based on consideration remitted by a subscriber local to said subscriber station.

37. The method according to claim 15 or claim 26 wherein said prioritization criteria is a based on whether sufficient bandwidth is available.

38. The method of claim 33 wherein said consideration is monetary.

39. The voicemail server according to claim 14 or the methods according to claim 15 or 16 wherein said voicemail is sent from said voicemail client to said voicemail server according to a prioritization criteria.

40. The voicemail server according to claim 14 or the methods according to claim 15 or 16 wherein said voicemail is sent from said voicemail server to said voicemail client according to a prioritization criteria.

41. The system according to claim to claim 1 wherein said first node is a first subscriber station equipment respective to a first subscriber premises and said second node is a second subscriber station equipment respective to a second subscriber premises and said communication link is any pathway through a telecommunication network interconnecting said first node and said second node.
